(19) United States
(12) Patent Application Publication
(10) Pub. No.: US 2006/0011683 A1
(43) Pub. Date: Jan. 19, 2006

(54) Personal watercraft cargo rack

(76) Inventor: Wayne Held, Lake Forest, CA (US)

Correspondence Address: John H. Lynn, Suite C 103, 2915 Redhill Ave., Costa Mesa, CA, 92626, US

(21) Appl. No.: 10/885,165

(22) Filed: Jul. 6, 2004

(51) Int. Cl. B60R 7/00

(52) U.S. Cl. 224/406

(57) ABSTRACT

A cargo rack is arranged to be easy to fasten to a rear deck region of a personal watercraft. The cargo rack holds items that personal watercraft users typically want to carry such as food and beverage containers, chairs, fuel containers, picnic supplies, etc. The cargo rack comprises a frame arranged to form a basket having a base arranged to rest upon an upper surface of the deck and a mounting bracket assembly connected to the base. The mounting bracket assembly includes a retainer guide having a passage therethrough mounted to the frame. A retainer rod extends through the passage in the retainer guide such that an upper portion of the retainer rod extends above the retainer guide and a lower portion of the retainer rod extends below the retainer guide and below the base of the frame.

### BACKGROUND OF THE INVENTION

This invention relates generally to a rack that may be mounted to a vehicle such as a personal watercraft for carrying articles such as food and beverage containers, chairs, etc.

Many personal watercraft enthusiasts enjoy traveling to remote locations for activities such as picnicking, camping and hiking. Most personal watercraft have a rear deck area where items such as beach chairs, coolers and sports equipment may be secured so that they may be transported. Typically such items are secured with ropes or elastic cords or straps. Merely fastening items to be transported to the deck of the personal watercraft Is an inefficient use of the available space. Some articles are difficult to fasten securely and thus become lost.

### SUMMARY OF THE INVENTION

This invention provides a cargo rack that is easy to fasten to a rear deck region of a personal watercraft. The cargo rack according to the invention conveniently holds items that personal watercraft users typically want to carry such as food and beverage containers, chairs, fuel containers, picnic supplies, etc.

A cargo rack according to the invention formed to be attached to a deck of a vehicle such as a personal watercraft near an edge of the deck comprises a frame arranged to form a basket having a base arranged to rest upon an upper surface of the deck and a mounting bracket assembly connected to the base. The mounting bracket assembly includes a retainer guide having a passage therethrough mounted to the frame. A retainer rod extends through the passage in the retainer guide such that an upper portion of the retainer rod extends above the retainer guide and a lower portion of the retainer rod extends below the retainer guide and below the base of the frame. The mounting bracket assembly further includes a retainer bracket having a first end connected to the lower portion of the retainer rod and a second end arranged to extend under the deck and a fastener arranged to fasten the retainer rod in the retainer guide so that a portion of the deck is held between the retainer bracket and the base to secure the cargo rack on the deck.

The cargo rack according to the invention preferably further comprises a strap arranged for fastening the frame to a portion of the personal watercraft.

The frame included in the invention is further arranged to comprise a hanger portion extending upward from the basket.

The retainer guide preferably includes a plurality of passages arranged to receive the retainer rod therein.

The retainer rod preferably includes a plurality of holes at an upper end portion arranged to receive a pin arranged to hold the retainer rod in a selected position in the retainer guide.

The retainer bracket preferably also includes a detent connected to the second end of the retainer bracket for engaging a lower surface portion of the deck to mount the cargo rack securely to the deck. The detent may be formed in a generally cylindrical configuration with a side surface portion thereof being connected to the second end of the retainer bracket.

The features of the invention may be understood and appreciated by referring to the accompanying drawings, which are not to any scale, and to the detailed description of the invention.

### BRIEF DESCRIPTION OF THE DRAWINGS

FIG. 1 is a perspective view of a cargo rack constructed according to the present invention;

FIG. 2 is a perspective view of a frame that may be included in the cargo rack of FIG. 1;

FIG. 3 is a front elevation view of the cargo rack of FIG. 1 that also includes a first strap that may be used in mounting the cargo rack to a vehicle and a second strap that may be used to secure items in the cargo rack;

FIG. 4 is a side elevation view of the cargo rack of FIGS. 1 and 3 showing how the invention may be mounted to a rear deck portion of a personal watercraft;

FIG. 5 is a plan view of the frame shown in FIG. 2;

FIG. 6 is a plan view of the cargo rack of FIG. 1;

FIG. 7 is a partial side elevation view of the invention as shown in FIGS. 1 and 6; and

FIG. 8 is a partial cross sectional view showing how the cargo rack according to the invention may be secured to a rear deck portion of a personal watercraft.

### DETAILED DESCRIPTION OF THE INVENTION

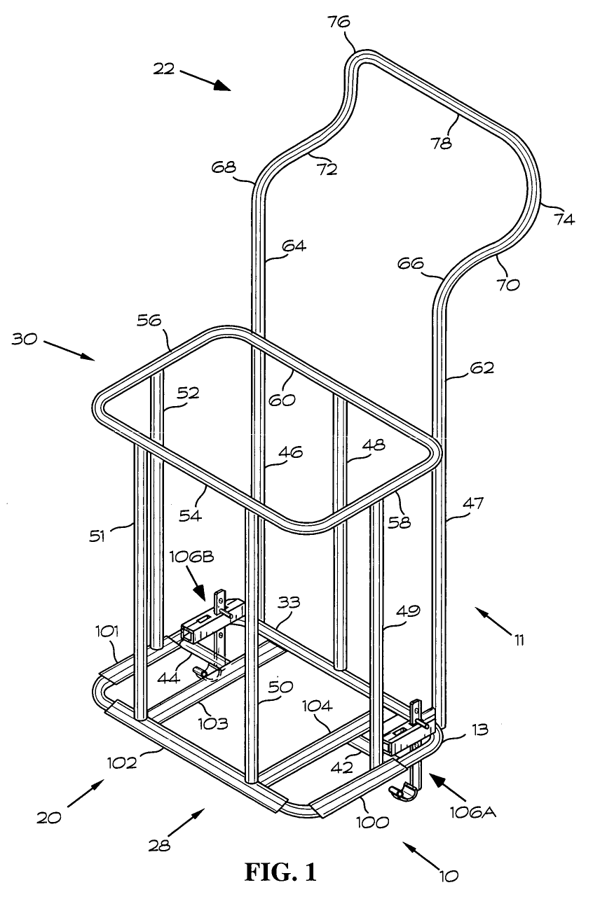

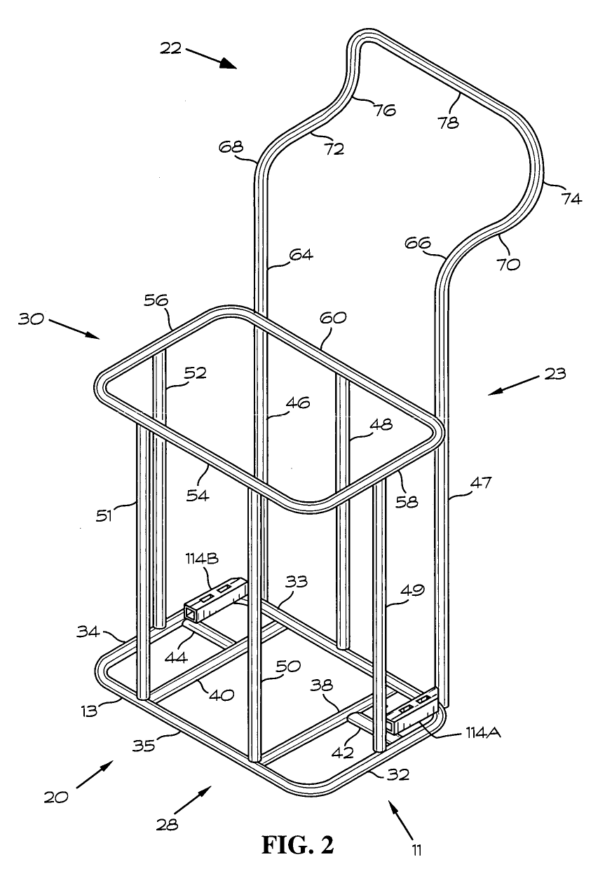

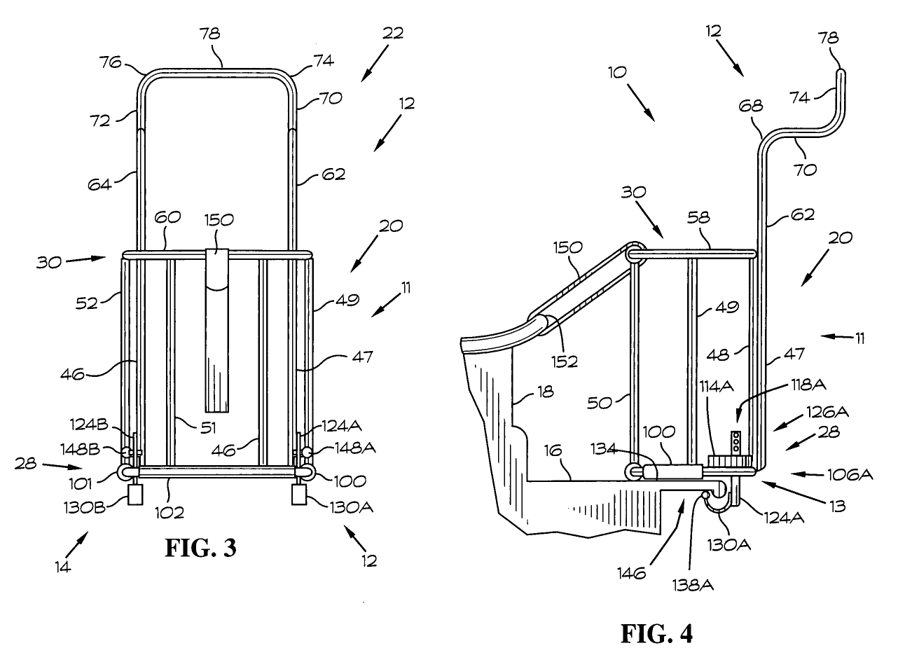

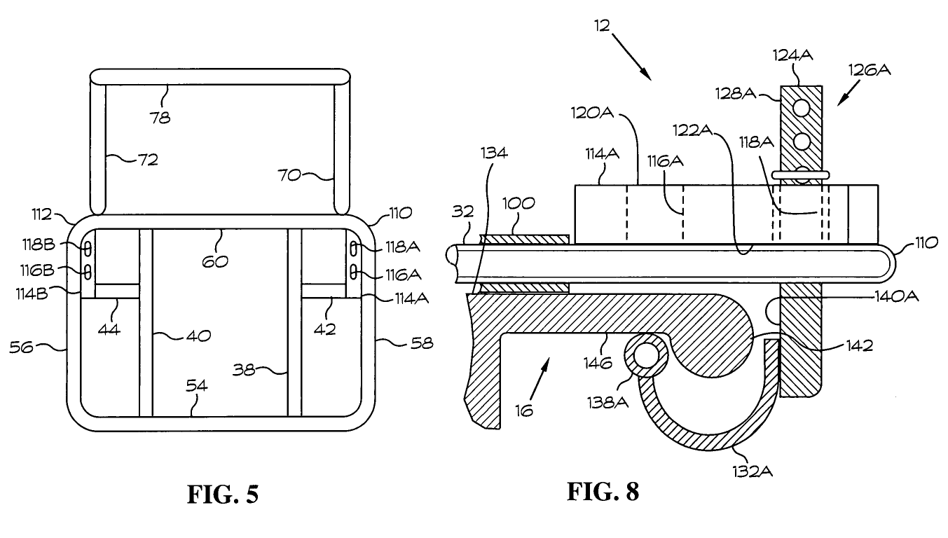

As shown in FIGS. 1-5, a cargo rack 10 includes a frame 11 arranged for fastening the frame to a rear deck portion 16 of a vehicle 18 such as a personal watercraft. The frame 11 preferably is of tubular construction using any suitable material such as aluminum, steel, plastic etc.

The frame 11 has a base 13 that rests upon the deck portion 16. The cargo rack 10 preferably is formed to include a basket portion 20 with a hanger portion 22 extending from the basket portion 20. When the cargo rack 10 is mounted on the vehicle 18, the hanger portion 22 preferably extends upward from a rear portion 23 of the basket 20. The base 13 preferably forms a lower portion 28 of the basket 20 and is preferably formed generally a rectangle having rounded corners. The basket has an upper portion 30 that preferably has approximately the same dimensions as the lower portion 28.

The lower portion 28 may be defined by a tubular member 31 that is formed as a rectangle having rounded corners. The lower portion 28 has sides 32-35. The sides 33 and 35 are parallel and have first and second tubular support members 38 and 40 extending perpendicularly therebetween. A third tubular support member 42 may be arranged to extend between the side 32 and the first support member 38. A fourth tubular support member 44 may be similarly arranged to extend between the side 34 and the second support member 40. The support members 42, 44, 103 and 104 with the base 13 form the bottom of the basket 20.

The basket portion 20 may further include a plurality of upright tubular members 46-52 extending perpendicularly between the lower portion 28 and the upper portion 30 of the basket 20. The upper portion 30 preferably is arranged to be generally parallel to the lower portion 28. The tubular members 50 and 51 are parallel and are arranged to support a front side 54 of the upper portion 30. The members 49 and 52 support opposite sides 56 and 58 of the upper portion 30. The tubular members 46-48 support a rear side 60 of the upper portion 30.

The tubular members 46 and 47 extend beyond the upper portion 30 of the basket and form the hanger portion 22. The tubular members 46 and 47 each preferably have straight sections 62 and 64, respectively, that extend away from the upper section 30 of the basket. The members 46 and 47 preferably have curved portions 66 and 68, respectively, formed between the upper ends of the vertical straight sections 62 and 64 and straight sections 70 and 72, respectively. The curved portions 66 and 68 preferably form arcs of about 90° so that the straight sections 70 and 72 are essentially horizontal when the cargo rack 10 is mounted to a personal watercraft. Upwardly curved sections 74 and 76 are preferably formed at the outer ends of the straight sections 70 and 72, and a horizontal bar 78 extends between the upwardly curved sections 74 and 76.

The straight horizontal sections 70 and 72 are conveniently arranged so that typical beach, lawn chairs (not shown) etc. may be hung from them. Suitable strapping or elastic bands (not shown) may be used to fasten items hanging from the straight horizontal sections 70 and 72 to any of the frame members 46-48.

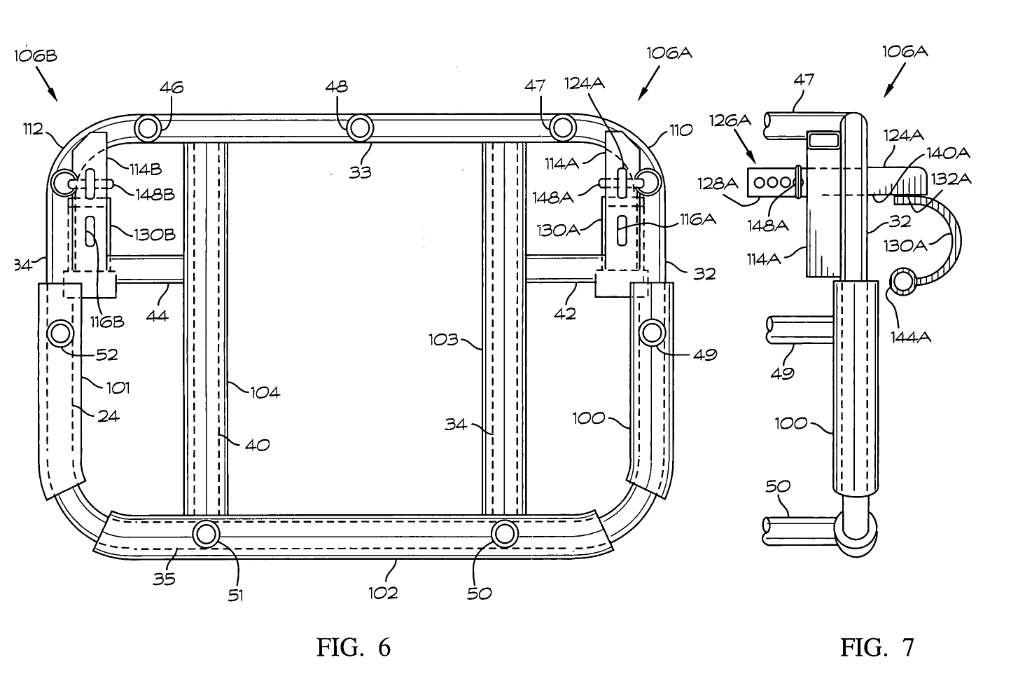

As best shown in FIGS. 1, 3, 4, 6 and 7 sleeves 100-104 may be placed around portions of the frame members 32, 34, 35, 38 and 40, respectively. The sleeves 100-104 preferably are formed of foam, rubber or other similar substance and are arranged to provide cushioning between the frame 11 and the upper surface of the rear deck 16 of the personal watercraft 18.

As best shown in FIGS. 1, 4, 7 and 8, the mounting bracket assemblies 106A and 106B are connected to the frame near corners 110 and 112, respectively. The mounting bracket assemblies 106A and 106B are preferably essentially identical. Therefore, only the mounting bracket assembly 106A is described in detail herein. Components of the mounting bracket assembly 106A are referenced by a number are referenced by a number followed by the letter “B.”

The mounting bracket assembly 106A includes a retainer guide 114A that is fastened to the frame member 32 by any suitable means such as welding. The retainer guide 114A is preferably formed of a length of metal tubing having rectangular side surfaces. A pair of preferably rectangular passages 116A and 118A is formed to extend through the retainer guide 114A from the top surface 120A to the bottom surface 122A. As shown in FIG. 8, the passages 116A and 118A are arranged to receive therein a retainer rod 124A having a plurality of passages 126A extending through an upper portion 128A thereof. A retainer bracket 130A is connected to a lower portion 132A of the retainer rod 124A. The retainer bracket 130A is preferably formed so that in the side elevation views of FIGS. 4 and 8 it is configured generally

As shown in FIGS. 4 and 8, when the cargo rack 10 is mounted to a deck 16 of a personal watercraft 18, the sleeves 100-104 contact an upper portion 134 of the deck 16 while the front edge 140A of the retainer rod 124A is near the rear edge 142 of the deck 16. The retainer bracket 130A extends from the front edge 140A under the deck 16. The retainer rod 124A is positioned in a selected one of the passages 116A or 118A so that an outer end portion 144A of the retainer bracket 130A contacts the bottom surface 146 of the deck 16. A pin 148A may be inserted in one of the passages 126A to hold the retainer rod 124A in the proper position in the retainer guide 114A to hold the retainer bracket 130A against the bottom surface 146 of the deck 16.

As shown in FIG. 4, a strap 150 may be used to secure the bar 54 in the upper portion 30 of the basket 20 to a portion 152 of the personal watercraft 18. The portion 152 usually is a bar that extends behind the seat (not shown) of the personal watercraft 18. Additional strapping (not shown) may be used to secure articles such as beach chairs to the cargo rack 10 or to prevent articles from being ejected from the basket 20.

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. A cargo rack formed to be attached to a deck of a vehicle such as a personal watercraft near an edge of the deck, comprising:
a frame arranged to form a basket having a base arranged to rest upon an upper surface of the deck;
a mounting bracket assembly connected to the base, the mounting bracket assembly including:
a retainer guide mounted to the frame, the retainer guide having a passage therethrough;
a retainer rod extending through the passage in the retainer guide such that an upper portion of the retainer rod extends above the retainer guide and a lower portion of the retainer rod extends below the retainer guide and below the base of the frame;
a retainer bracket having a first end connected to the lower portion of the retainer rod and a second end arranged to extend under the deck; and
a fastener arranged to fasten the retainer rod in the retainer guide so that a portion of the deck is held between the retainer bracket and the base to secure the cargo rack on the deck.

2. The cargo rack of claim 1, further comprising a strap arranged for fastening the frame to a portion of the personal watercraft.

3. The cargo rack of claim 2 wherein the frame is further arranged to comprise a hanger portion extending upward from the basket.

4. The cargo rack of claim 1 wherein the frame is further arranged to comprise a hanger portion extending upward from the basket.

5. The cargo rack of claim 1 wherein the retainer guide includes a plurality of passages arranged to receive the retainer rod therein.

6. The cargo rack of claim 5 wherein the retainer rod includes a plurality of holes at an upper end portion thereof further comprising a pin arranged for insertion into a selected one of the holes to hold the retainer rod in a selected position in the retainer guide.

7. The cargo rack of claim 1 wherein the retainer bracket includes a detent connected to the second end of the retainer bracket for engaging a lower surface portion of the deck to mount the cargo rack securely to the deck.

8. The cargo rack of claim 7 wherein the detent is formed in a generally cylindrical configuration with a side surface portion thereof being connected to the second end of the retainer bracket.
